(19) United States
(12) Patent Application Publication
(10) Pub. No.: US 2005/0074317 A1
(43) Pub. Date: Apr. 7, 2005

(54) Cart to lift barrels

(76) Inventors: Francisco Pallares Escorza, Malaga (ES); Eduardo Ivan Galvez Leueratto, Miami, FL (US)

Correspondence Address: Ivan Galvez, 5131 SW 151 PL, Miami, FL, 33185, US

(21) Appl. No.: 10/678,360

(22) Filed: Oct. 3, 2003

(51) Int. Cl. B62B 1/06

(52) U.S. Cl. 414/444

(57) ABSTRACT

The cart to lift barrels is a new way of lifting barrels. It has an improve lift handle with an upper angular shape grip that finds the center of gravity of the barrels when lifting the barrel. It also has a new style rounded support or curve shape on the bottom of the cart that helps the barrel to be locked in place and helps the barrel not to slip to a side when carried. The cart to lift barrels in addition has a hook on the top that will fasten the barrel from the top in place with different positions that will aloud fasten different size barrels.

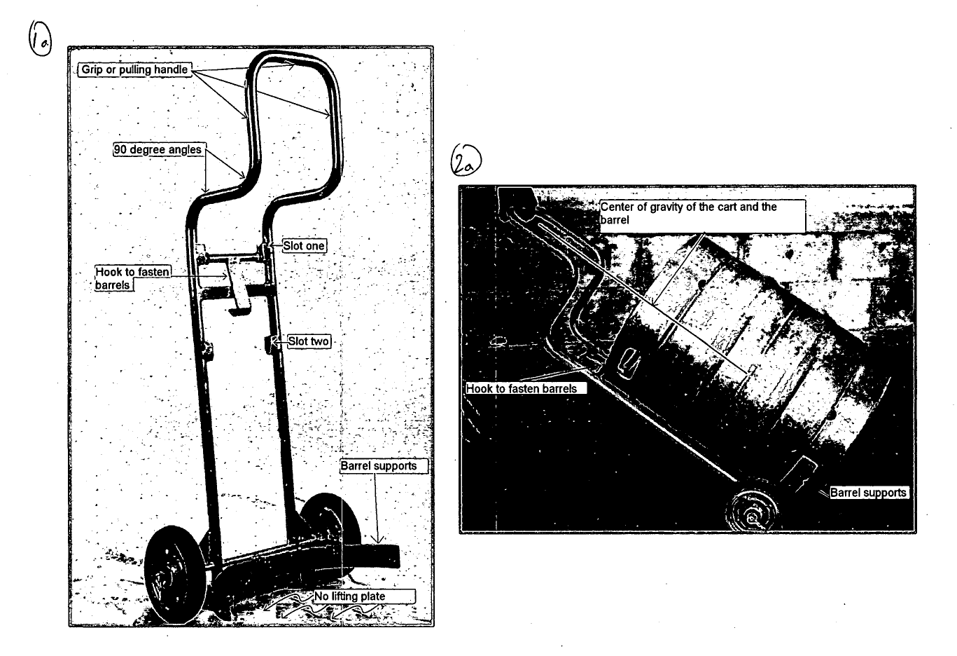

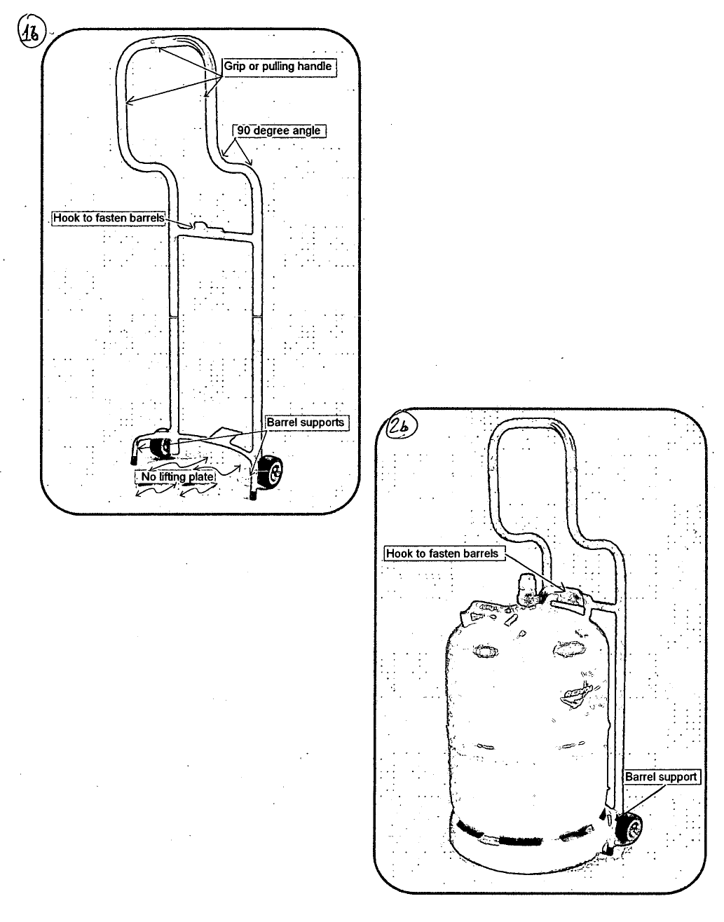

Eduardo Ivan Galvez, US citizen with residence at 5131 SW 151 PL Miami, Fla 33185, and Francisco Pallares Escorza, Spanish citizen with residence in Calle Hernán Cortes #3 edificio La Fuente 2A Fuengirola 29640, Malaga, Spain are the two inventors of the title to lift barrels. The cart to lift barrels is designed to easily pick up barrel from the ground with out the effort of lifting the barrel into the cart. Usually a conventional cart has a flat surface were objects are carried and place on top of the that flat surface. The cart to lift barrels has no flat surface to place objects. It works by holding the object or barrel by the side. Its design allows the cart to lift barrels to embrace the barrel. The bottom of the cart to lift barrels has a curve shape support for a perfect fit while a fastener safely securing the top for secure transportation. A hook securely holds the barrel from the top while the ergonomically curved handle reduces the effort of lifting and moving the barrel around. This is due to the center of gravity of the barrel and the grip of the cart beingin the same line. I am also including the smaller version of the cart, which is used for smaller barrels such as a propane tanks. It has the same functionality shape and utility as of the bigger size model with no differences but it size. Both are made to hold barrels and to carry them or move them to a different position or place.

### CROSS-REFERENCE TO RELATED APPLICATIONS

N/A

### STATEMENT REGARDING FEDERALLY SPONSORED RESEARCH OR DEVELOPMENT

N/A

### REFERENCE TO SEQUENCE LISTING, A TABLE OR COMPUTER PROGRAM LISTING COMPACT DISC APPENDIX

N/A

### BACKGROUND OF THE INVENTION

The cart to lift barrels is meant to be used in the field of barrel transportation either by the distributor, the supplier or the end user. It is meant to reduce the effort of handling heavy barrels such as beer barrels, paint barrels or any other types of barrels. The purpose is to reduce the effort made by the user by lifting and transporting barrels. The problem with conventional lift carts is that they are designed to carry objects such as boxes. Boxes have flat surfaces which allow easy pick up and transportation when using a cart; however, barrels are round and more difficult to maneuver. This invention is specifically designed to handle barrels. The idea is to leave the space in between the vertical bars of the cart open so the rounded shape of the barrel can perfectly fit the cart. The bottom of the cart has a curved shape that allows a barrel to be position in place. Additionally, the barrel lift cart has a hook that attaches the barrel to the cart and is used as a pulling agent to lift the barrel from the ground. Also, the curved ergonomic shaped grips helps reduce the effort of lifting and moving the barrel around and makes it feel lighter. The reason is that the center of gravity of the barrel and the grip of the cart are at the sane position making it easier for the user to lift the barrel.

### BRIEF SUMMARY OF THE INVENTION

The cart to lift barrels would help any person regardless of age or size to lift barrels easily. The cart to lift barrels was made specifically for barrels lifting and transportation. The cart to lift barrels was engineered to help a user lift and carry barrels more efficiently and with less effort than other lifting carts. Its design was meant to be for the accommodation of a barrel in its structure for support; therefore, easier transportation. By addressing the center of gravity of the barrel, the center of gravity of the cart to lift barrels, and the grip of the cart a user would enjoy a more stable transportation. As a result the cart to lift barrels presents a safer way of transporting barrels. In addition, the cart to lift barrels was made to help reduce physical challenges when lifting heavy objects that could result in body injuries or accidents. The smaller size barrel lifting cart is similar in all means to the bigger version.

### BRIF DESCRIPTION OF THE SEVERAL VIEWS OF THE DRAWINGS

N/A

### DITAILED DESCRIPTION OF THE INVENTION

The empty space between the cart to lift barrels vertical bars was design to place a barrel in the middle of the bars and help the round shape of the barrel to come in between.

The curve shape support on the bottom of the cart to lift barrels was made to embrace the barrel in place when careening it and also to make sure the barrel would not slide to one side or the other when in movement

The hook on the upper part of the cart that is used to fasten the barrel to the cart can be removed or place on two different slots one higher that the other depending on the size of the barrel that is meant to be carried

The grip or upper part of the cart has an angular shape towards the front of the cart with two 90 degree angles. The first one going forward and the second going upwards making the grip or handle of the cart to be on a forward position matching the vertical center of gravity of the barrel and making the cart a pulling agent with the same center of gravity as the barrel that is going to be pulled.

The wheels of the cart are meant to move the cart with or with out the cargo.

The barrel lifting cart (both the small and the big one) were made of steel pipes strong enough to withstand heavy loads or heavy barrels.

1. We claim the upper angular shape of the cart or grip that finds the center of gravity of the barrels when lifting the barrel

2. We clam the rounded or curve shape of the bottom of the cart that helps the barrel to be locked in place and helps the barrel not to slip to a side when carried

3. We claim the hook on the top that will fasten the barrel from the top in place

4. We claim the different positions of the hook that will aloud fasten different size barrels.
